(19) United States
(12) Patent Application Publication
(10) Pub. No.: US 2018/0169753 A1
(43) Pub. Date: Jun. 21, 2018

(54) Aluminum nanosheet, its preparing method and use thereof

(71) Applicant: Beijing University of Chemical Technology, Beijing (CN)

(72) Inventors: Xiaoming SUN, Beijing (CN); Liang LUO, Beijing (CN); Yang LI, Beijing (CN)

(73) Assignee: Beijing University of Chemical Technology, Beijing (CN)

(21) Appl. No.: 15/810,124

(22) Filed: Nov. 12, 2017

(30) Foreign Application Priority Data
Dec. 19, 2016 (CN) 201611180111.0

(51) Int. Cl. B22F 1/00; B22F 9/24; C09K 11/64

(52) U.S. Cl. CPC B22F 1/0018; B22F 9/24; B82Y 40/00; B22F 2001/0033; C09K 11/64

(57) ABSTRACT

The invention provides an aluminum nanosheet, having an equivalent diameter of 50 to 1000 nm, and a thickness of 1.5 to 50 nm. The invention further provides a method for preparing the aluminum nanosheet and the use thereof as a two-photon light emitting material or a Raman enhanced material.

### CROSS REFERENCE TO RELATED APPLICATIONS

This application is based upon and claims priority to Chinese Patent Application No. CN201611180111.0, filed on Dec. 19, 2016, the entire content of which is incorporated herein by reference.

### TECHNICAL FIELD

The invention relates to the field of advanced inorganic nanomaterial, and particularly to an aluminum nanosheet and preparation method and use thereof.

### BACKGROUND

Aluminum is a metal element that are most abundantly present in the lithosphere, and in metal varieties, its present amount is only inferior to iron, being a second class of metal. Aluminum and aluminum alloys are materials that are widely used and most economic at now. With the progress in nanometer technology, nano-sized aluminum metal materials are paid more and more attention due to their good plasmon resonance characteristics and high energy density.

Plasmonic metals attract wide attentions due to the structure-dependent local surface plasmmon resonance (LSPR) characteristic. However, so far, studies on the plasmonic metals are mostly focused on precious metal materials, e.g., silver and gold, and each of them has a strong morphologically dependent plasmon resonance spectrum absorption characteristic. By adjusting the morphologies of noble metals, such as gold and silver, the adjustment from visible light spectrum region to infrared spectrum region can be mutually achieved. The ultra violet spectrum region is always a “blind spot” of the local surface plasmon resonance spectrum of metal nano-materials, and this seriously restricts the application of the metal nano-materials in the biological field. Since the emergence of aluminum nano-materials as prepared based on physical methods, the spectrum data of the UV region is supplemented so that the local surface plasmon resonance of metals is adjustable from the UV spectrum region to the near infrared spectrum region, thereby to greatly expand applications of metal materials.

In addition, as compared to conventional energetic materials, aluminum nanomaterials become a unique component of rocket propellant and explosive formulations due to high energy density, low oxygen consumption and high reactive activity. However, because of the very high metal activity, the nanomaterials are easily oxidized during applications. When the particles are in the nano-size, the oxidization degree is increased, and this will seriously influence the ignition characteristic and combustion rate of the particles.

Currently, synthesis methods for metal aluminum nanomaterials that are most widely used include mechanical ball grinding, vapor phase evaporation deposition and liquid phase chemical synthesis. The mechanical ball grinding method is conducive to the realization of large scale production, whereas in this method, impurities are ready to be introduced, and the homogeneity of the particle shape is poor. As for the vapor phase condensation, products as prepared therefrom have high purity, whereas this method highly requires associated equipment, and the morphologies of the products are not easily controlled. As for commonly-used liquid phase chemical synthesis, the method provides possibilities to control the morphology of the resultant product, whereas during the preparation according to the method, the products are easily agglomerated and thus the method is not easily popularized.

### SUMMARY OF THE INVENTION

In order to solve the above problems, the invention is proposed.

The first aspect of the invention provides an aluminum nanosheet, having an equivalent diameter of 50 to 1000 nm, and a thickness of 1.5 to 50 nm.

When the term “equivalent diameter” is used to describe the dimension of a non-round plane, it is meant to a diameter of a round that has the same area as that of the non-round plane.

The second aspect of the invention provides a method for preparing the aluminum nanosheet, comprising the steps of:

(1) preparing a reaction solution A by adding an aluminum source and an organic ligand to a first organic solvent;
(2) preparing a reaction solution B by adding lithium aluminum hydride to a second organic solvent;
(3) performing a reductive reaction by adding the reaction solution B to the reaction solution A, and then reacting the resultant mixture at 100° C. to 165° C. for 1 to 72 hours, to produce an aluminum nanosheet suspension;
(4) solid-liquid separating the above aluminum nanosheet suspension, wherein the produced solid is the aluminum nanosheet.

In a preferred embodiment, the solid-liquid separating in the step (4) comprises the steps: centrifugation concentration, then ultrasonic washing, and at last vacuum drying, in which the washing liquid as used in the ultrasonic washing is one selected from the group consisting of acetone, methanol, and ether or a mixture thereof.

In a preferred embodiment, the aluminum source in the step (1) is one selected from the group consisting of aluminum chloride, aluminum acetylacetonate, and aluminum acetate or a mixture thereof; said organic ligand is one selected from the group consisting of polyethylene glycol, polyvinylpyrrolidone, polymethylmethacrylate, polyethylene glycol dimethyl ether and oleylamine; the first and second organic solvents, independently of each other, are one or more selected from the group consisting of toluene, mesitylene and butyl ether.

In a preferred embodiment, the amount of the organic ligand is selected so that the molar ratio of the ligand to the theoretically resultant aluminum nanosheet is 1:(0.01-5).

In a preferred embodiment, when aluminum chloride is used as the aluminum source, the concentration of aluminum chloride is from 0.01 to 1 mol/L, and the molar ratio of aluminum chloride to lithium aluminum hydride is 1:(0.1-4); when aluminum acetylacetonate or aluminum acetate is used as the aluminum source, the concentration of aluminum acetylacetonate or aluminum acetate is from 0.01 to 1 mol/L, and the molar ratio of aluminum acetylacetonate or aluminum acetate to lithium aluminum hydride is 1:(0.05-3).

In a preferred embodiment, the reductive reaction in the step (3) is performed under oxygen-containing atmosphere under autogenous pressure in a closed reaction vessel, wherein the oxygen-containing atmosphere means oxygen concentration is from 15 vol % to 50 vol %; alternatively, the reductive reaction is performed under normal pressure in an opening reaction vessel.

The atmosphere in the closed reaction vessel may be controlled by any method known in the art to make it to be the oxygen-containing atmosphere, such as, but are not limited to: by first venting the air in the closed reaction vessel and then enter a nitrogen/oxygen gas mixture with predetermined proportion, or, by adding a substance capable of generating oxygen gas to the reaction solution to produce oxygen in situ in the closed reaction vessel, and the like.

In a preferred embodiment, the reaction solution B is added into the reaction solution A once or in portions. When the reaction solution B is added to the reaction vessel once, the nucleation and growth of the aluminum nanosheet is completed in one step; when the reaction solution B is added to the reaction solution in portions, the formation of the aluminum nanosheet substantially includes nucleation and then growth.

In a preferred embodiment, the thickness of the prepared aluminum nanosheet is reduced by selecting organic ligands having a higher mass proportion of nitrogen or oxygen element; alternatively, when the same one organic ligand is used, the thickness of the prepared aluminum nanosheet is reduced by reducing the molar ratio of the organic ligand to the aluminum source.

The third aspect of the invention is to provide the use of the aluminum nanosheet according to the first aspect of the invention as a two-photon light emitting material or a Raman enhanced material.

In a preferred embodiment, the aluminum nanosheet according to the first aspect of the invention are used for increasing the light emitting intensity of the two-proton light emitting material, or, by reducing the thickness of the aluminum nanosheet, for expanding its intrinsic light emitting region from the ultraviolet region to the near infrared region.

The present invention can achieve the following advantageous effects:

1. The aluminum nanosheet according to the invention not only are not reported, but also have excellent properties. The thickness of the nanosheet according to the invention may be lowered to 1.5 nm, and the equivalent diameter can reach 1000 nm.
2. The aluminum nanosheet as prepared by the method according to the invention has an independently adjustable thickness, and the thickness may be adjusted by changing the kind of the organic ligand and the corresponding concentration thereof. Depending on the differences in the kind of the ligand and corresponding concentrations thereof, the thickness of the thinnest aluminum nanosheet may be 1.5 nm.
3. As compared to methods for the preparing the aluminum nanomaterials in the art, during the preparation of the aluminum nanosheet according to the invention, since added different organic ligands have selective absorptions to the lattice plane (111) of aluminum, the prepared aluminum nanosheet have a high sheet formation rate and a low particle content.
4. The light emitting intensity of the two-proton light emitting material of the aluminum nanosheet according to the invention is 4 times higher than that of gold rods having an aspect ratio of 4.
5. The preparing method of the present invention must be carried out in the oxygen-containing atmosphere. In the case where the other experimental conditions are the same, aluminum nanosheet can be obtained in the oxygen-containing atmosphere with an oxygen concentration of from 15 vol % to 50 vol % according to the present invention, otherwise only aluminum nanoparticles can be obtained.

### BRIEF DESCRIPTION OF THE DRAWINGS

FIG. 1A is a diagram of the scanning electron microscope (SEM) of the aluminum nanosheets as prepared in Embodiment 1, in which the aluminum nanosheets have a diameter of about (80±10) nm, and a thickness of about (5±2) nm.

FIG. 1B is a diagram of scanning electron microscope (SEM) of the aluminum nanosheets as prepared in Embodiment 2, in which the aluminum nanosheets have a diameter of about (100±10) nm, and a thickness of about (6±2) nm.

FIG. 1C is a diagram of scanning electron microscope (SEM) of the aluminum nanosheets as prepared in Embodiment 3, in which the aluminum nanosheets have a diameter of about (100±10) nm, and a thickness of about (8±2) nm.

FIG. 1D is a diagram of scanning electron microscope (SEM) of the aluminum nanosheets as prepared in Embodiment 4, in which the aluminum nanosheets have a diameter of about (1000±30) nm, and a thickness of about (18±5) nm.

FIG. 1E is a diagram of scanning electron microscope (SEM) of the aluminum nanosheets as prepared in Embodiment 5, in which the aluminum nanosheets have a diameter of about (100±10) nm, and a thickness of about (6±2) nm.

FIG. 1F is a diagram of scanning electron microscope (SEM) of the aluminum nanosheets as prepared in Embodiment 6, in which the aluminum nanosheets have a diameter of about (230±10) nm, and a thickness of about (2±0.5) nm.

FIG. 2A is a diagram of high amplification transmission electron microscope (TEM) of the aluminum nanosheets as prepared in Embodiment 7.

FIG. 2B is a diagram of high amplification transmission electron microscope (TEM) of the aluminum nanosheets as prepared in Embodiment 2.

FIG. 2C is an enlarged view of the high amplification transmission electron microscope (TEM) of the aluminum nanosheets as shown in FIG. 2A, in which the thickness of the aluminum nanosheets is 2.0 nm.

FIG. 2D is an enlarged view of the high amplification transmission electron microscope (TEM) of the aluminum nanosheets as shown in FIG. 2B, in which the thickness of the aluminum nanosheets is 7.0 nm.

FIG. 3 is a diagram of X-ray powder diffraction (XRD) of the aluminum nanosheets as prepared in Embodiment 3. As shown in FIG. 3, it can be expressly known that the material according to the invention is a metal aluminum having a Face-Centered-Cubic (fcc) crystal form, and the prepared material has an obvious orientation to expose the lattice plane (111).

FIG. 4 is a diagram of X-ray photoelectron spectroscopy (XPS) as measured after the aluminum nanosheets as prepared in Embodiment 3 of the invention is placed in air for a week. The X-ray Photoelectron Spectroscopy is an important surface analytic technique that can analyze and confirm the surface chemical composition and element chemical states of a material. From FIG. 4, the relative ratio of the element aluminum to its oxides can be clearly seen. That is, the proportion of the elemental aluminum is 75%, and the oxidization degree of the element is weak.

FIG. 5 shows the light emitting situations of the product by taking the single-particle dark-field scattering images of the aluminum nanosheets as prepared in Embodiment 2 (with the thickness of 6 nm), Embodiment 4 (with the thickness of 18 nm) and Embodiment 6 (with the thickness of 2 nm) according to the invention as the Embodiments. The dark-field scattering imaging technique, as a non-scanning photo imaging technique having a high contrast, is widely used in analyzing and sensing, biological process tracing, and reaction monitoring fields. Because the single nanoparticle has the advantages of stable scattering light and high scattering efficiency, the single-particle dark-field scattering can better demonstrate the light emitting properties of the material. As seen from FIG. 5, the aluminum nanosheets as prepared in Embodiment 4 primarily emit light at 458 nm, and the aluminum nanosheets as prepared in Embodiment 6 primarily emit light at 725 nm. Thus, the spectrum of the aluminum nanosheets that have intrinsic light emitting in the UV region is successful expanded to the near infrared region.

FIG. 6 is a diagram of two-photon light emitting spectrum of the aluminum nanosheets as prepared in Embodiment 2 of the invention as captured under an exciting light with a wavelength of 800 nm and a powder of 50 mW.

FIG. 7 is a log (intensity) vs. log (powder) diagram obtainable by making some data treatments to the two-photon light emitting spectrum of the aluminum nanosheets as prepared in Embodiment 2 of the invention, with a slope of 2. As seen from the figure, the aluminum nanosheets as prepared according to the invention can be used as a two-proton material.

FIG. 8 shows the two-proton light emitting spectra of the aluminum nanosheets as prepared in Embodiment 2 (with the thickness of 6 nm), Embodiment 4 (with the thickness of 18 nm) and Embodiment 6 (with the thickness of 2 nm) according to the invention and a gold rod having an aspect ratio of 1:4 under an exciting light with a wavelength of 800 nm and a powder of 50 mW.

FIG. 9 is a diagram of high amplification scanning electron microscopy (SEM) of the aluminum nanosheets as prepared in Embodiment 7 according to the invention.

FIG. 10 is a diagram of high amplification scanning electron microscopy (SEM) of the aluminum nanosheets as prepared in Embodiment 8 according to the invention.

FIG. 11 is a diagram of high amplification scanning electron microscopy (SEM) of the aluminum nanosheets as prepared in Embodiment 9 according to the invention.

FIG. 12 is a diagram of high amplification scanning electron microscopy (SEM) of the aluminum nanosheets as prepared in Embodiment 10 according to the invention.

FIG. 13 is a diagram of low amplification scanning electron microscopy (SEM) of the aluminum nanoparticles as prepared in Embodiment 11.

### DETAILED DESCRIPTION OF THE INVENTION

The following text further describes the invention by combining the drawings and the examples. However, it should be understood that the following specific examples are only used for illustrating the invention, but not limiting the invention in any form.

### Embodiment 1

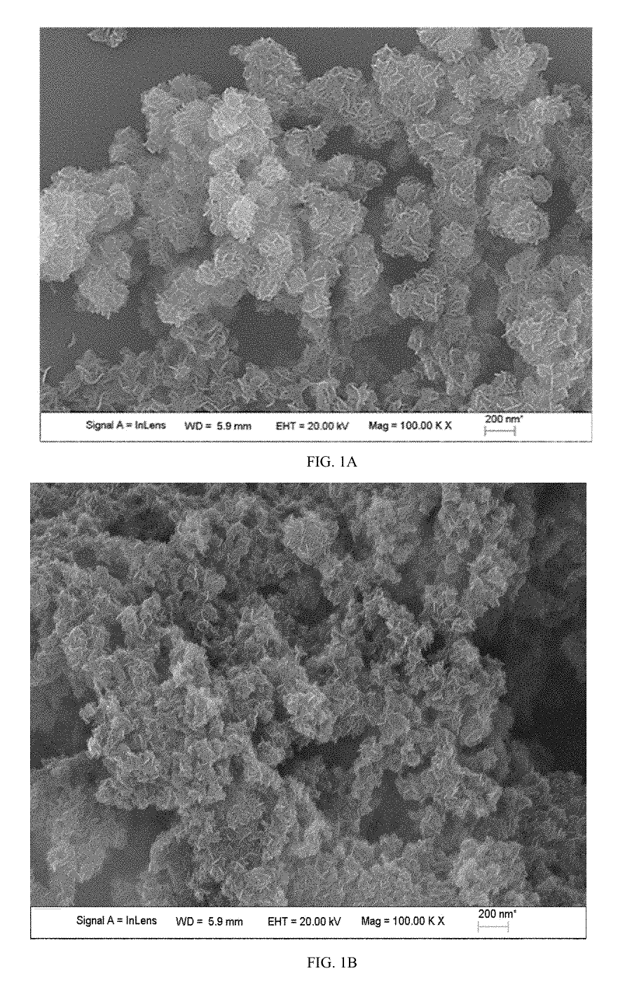

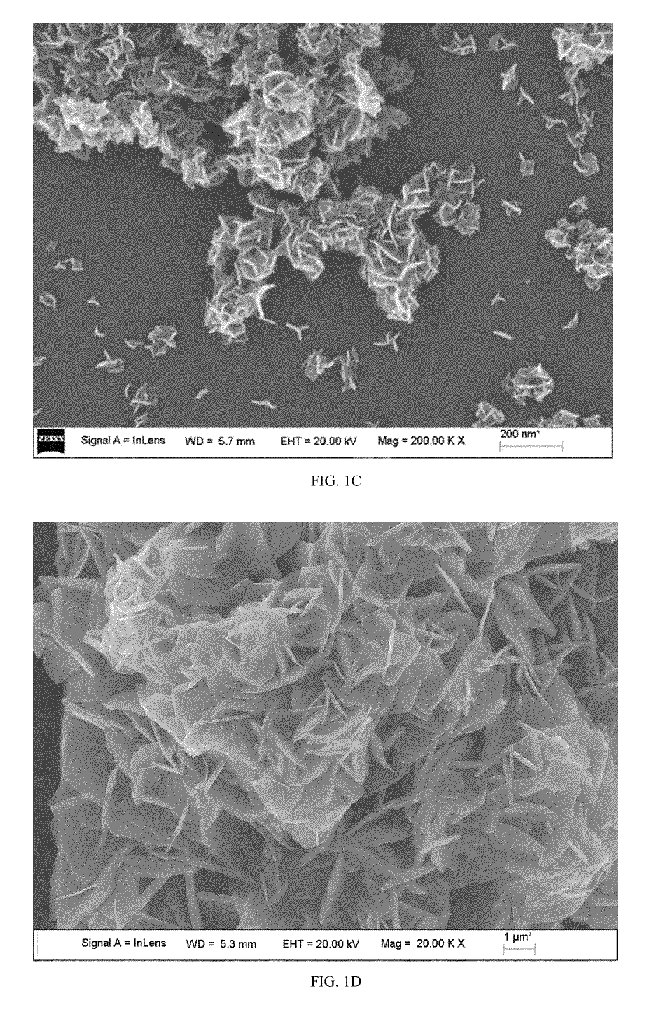

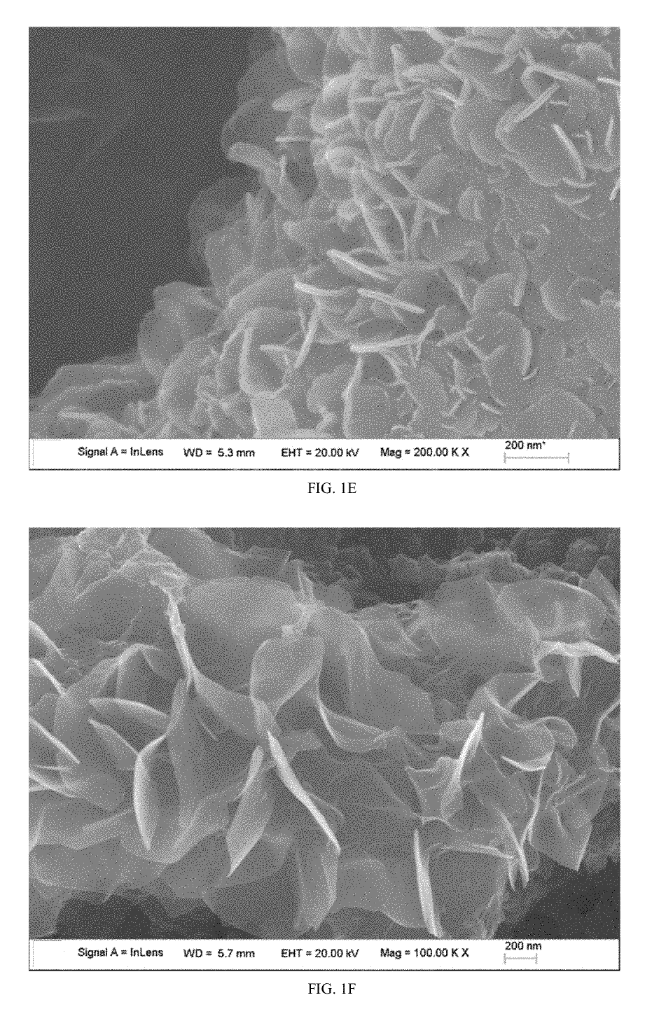

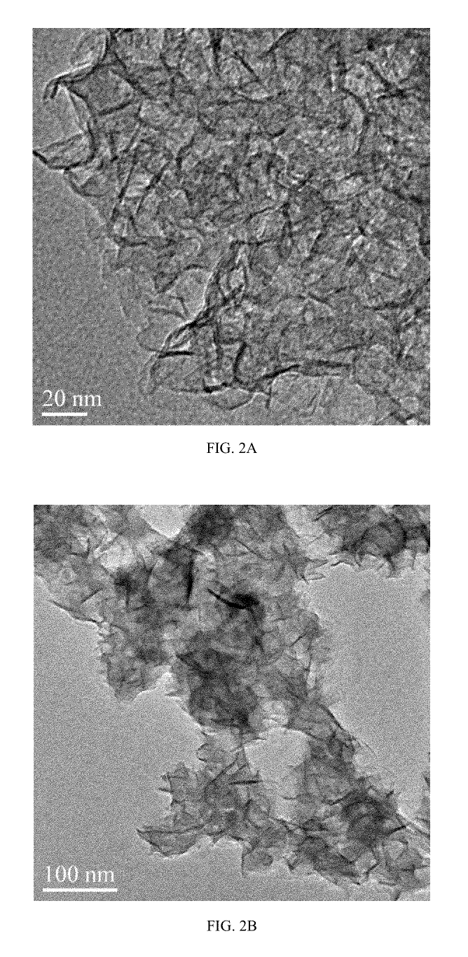

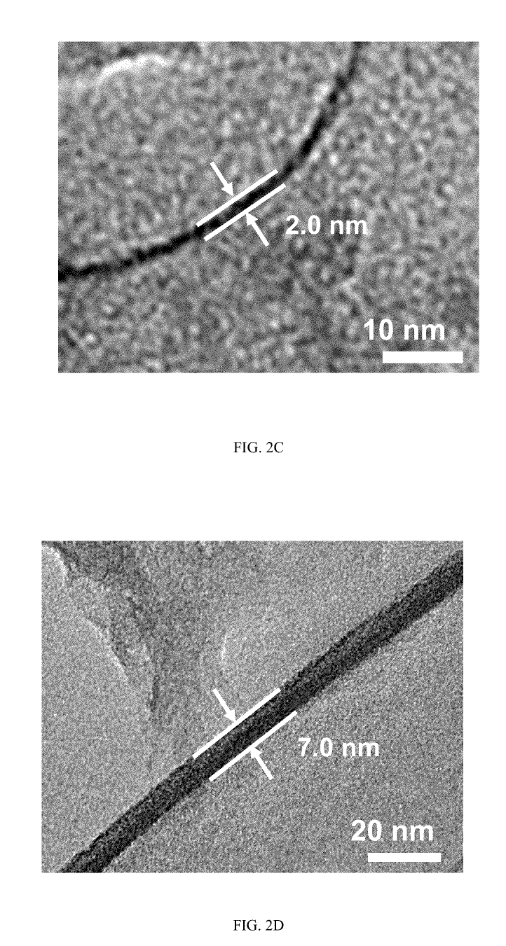

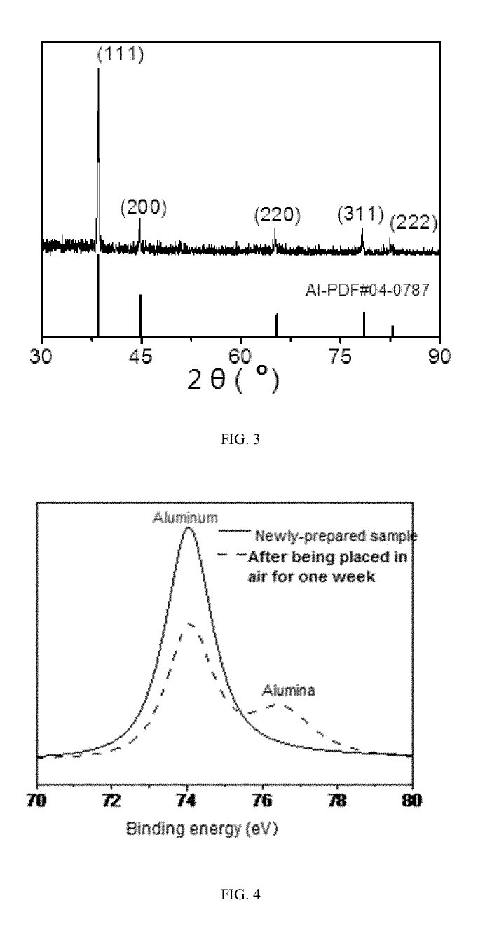

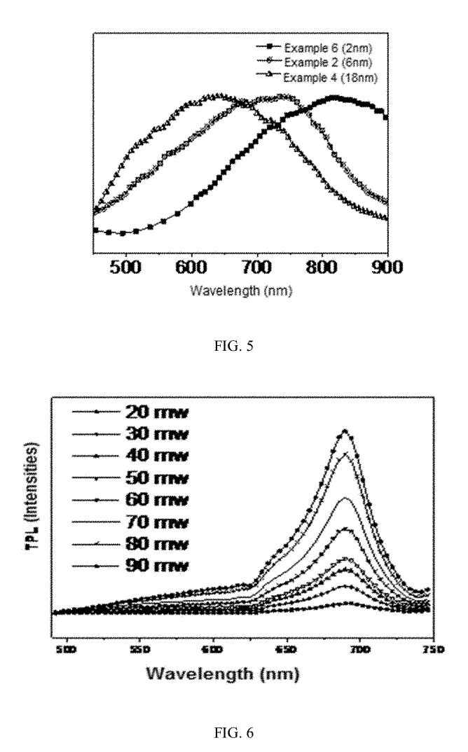

0.665 g of aluminum chloride (a metal salt), and 0.27 g of polyvinylpyrrolidone (PVP) were dissolved in 10 ml of mesitylene, and the resultant mixture was stirred at 80° C. for 5 minutes to fully dissolve the above materials therein, thereby to form a homogenous solution A. The resultant solution was transferred into a 25 ml flask. Thereafter, 0.57 g of lithium aluminum hydride (a reductive agent) was dissolved in 10 ml of mesitylene to form a solution B. The solution B was added to the above flask in once, and with violent stirring, the two solutions were homogenously mixed. The mixed solution was bubbled with nitrogen/oxygen mixed gas containing 20 vol % oxygen till saturation and the air above the liquid surface is vented. The flask was placed in an oil bath in which the reaction was carried on for 4 hours at 140° C., and then the flask was taken out of the oil bath and naturally cooled in air. The cooled solution was poured into a centrifugal tube to be centrifugation concentrated for 20 minutes with the rotary speed of 5000 rpm, and the resultant supernatant fluid was removed. Then, the concentrated suspension was dispersed with 15 ml of acetone, and after the dispersed suspension was ultrasonically treated for 5 minutes, it was centrifugation washed at the rotary speed of 8000 rpm. The above operations were repeated three times. The resultant product was dried under vacuum, and it was stored under oxygen isolation. FIG. 1A is a SEM diagram of the aluminum nanosheet as prepared in the example. The experimental results include: the diameter of about (80±10) nm, and the thickness of about (5±2) nm.

### Embodiment 2

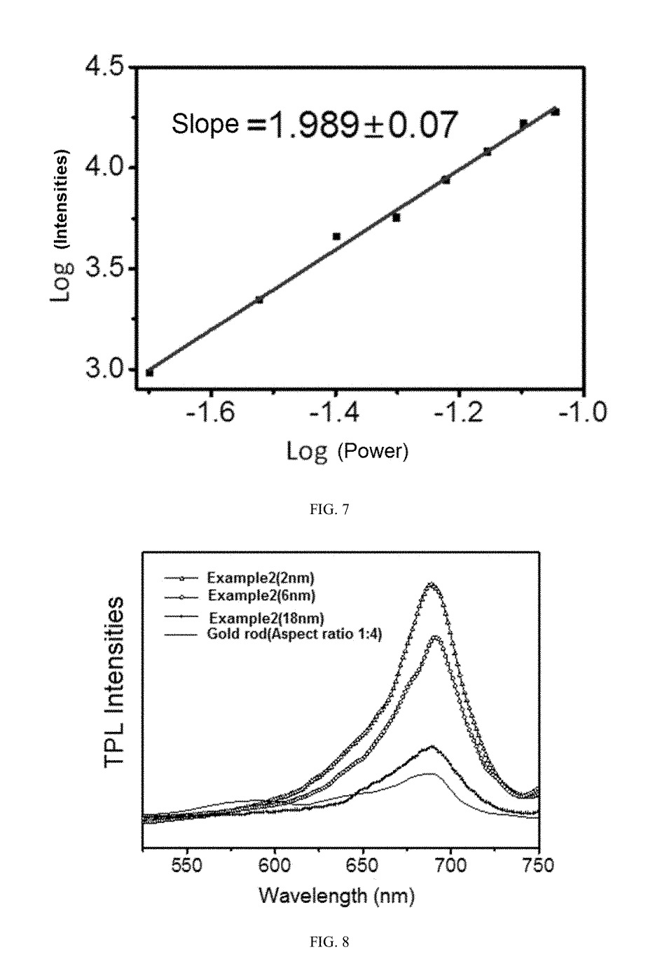

1.621 g of aluminum chloride (a metal salt), and 0.5 g of polyethylene glycol dimethyl ether (NHD) were dissolved in 10 ml of mesitylene, and the resultant mixture was stirred for at 80° C. 5 minutes to fully dissolve the above materials therein, thereby to form a homogenous solution A. The resultant solution was transferred into a 25 ml flask. Thereafter, 1.14 g of lithium aluminum hydride (a reductive agent) was dissolved in 10 ml of mesitylene to form a solution B. The solution B was added to the above flask in once, and with violent stirring, the two solutions were homogenously mixed. The mixed solution was bubbled with nitrogen/oxygen mixed gas containing 40 vol % oxygen till saturation and the air above the liquid surface is vented. The flask was placed in an oil bath in which the reaction was carried on for 10 hours at 140° C., and then the flask was taken out of the oil bath and naturally cooled in air. The cooled solution was poured into a centrifugal tube to be centrifugation concentrated for 20 min with the rotary speed of 5000 rpm, and the resultant supernatant fluid was removed. Then, the concentrated suspension was dispersed with 15 ml of ether, and after the dispersed suspension was ultrasonically treated for 5 minutes it was centrifugation washed at the rotary speed of 8000 rpm. The above operations were repeated three times. The resultant product was dried under vacuum, and it was stored under oxygen isolation. FIG. 1B is a SEM diagram of the aluminum nanosheet as prepared in the example. The experimental results include: the diameter of about (100±10) nm, and the thickness of about (6±2) nm. FIG. 6 and FIG. 7 respectively show the two-proton light emitting spectrum of the aluminum nanosheet as prepared in the example of the invention under exciting-lights with a wavelength of 800 nm but with different powers, and the diagram as obtained by making data treatments thereto.

### Embodiment 3

0.33 g of aluminum chloride (a metal salt), and 0.01 g of polyvinylpyrrolidone (PVP) were dissolved in 10 ml of mesitylene, and the resultant mixture was stirred at 80° C. for 5 minutes to fully dissolve the above materials therein, thereby to form a homogenous solution A. The resultant solution was transferred into a 25 ml flask. Thereafter, 0.057 g of lithium aluminum hydride (a reductive agent) was dissolved in 10 ml of mesitylene to form a solution B. The solution B was added to the above flask in once, and with violent stirring, the two solutions were homogenously mixed. The mixed solution was bubbled with nitrogen/oxygen mixed gas containing 30 vol % oxygen till saturation and the air above the liquid surface is vented. The flask was placed in an oil bath in which the reaction was carried on for 3 hours at 165° C., and then the flask was taken out of the oil bath and naturally cooled in air. The cooled solution was poured into a centrifugal tube to be centrifugation concentrated for 20 minutes with the rotary speed of 5000 rpm, and the resultant supernatant fluid was removed. Then, the concentrated suspension was dispersed with 15 ml of acetone, and after the dispersed suspension was ultrasonically treated for 5 min, it was centrifugation washed at the rotary speed of 8000 rpm. The above operations were repeated three times. The resultant product was dried under vacuum, and it was stored under oxygen isolation. FIG. 1C is a SEM diagram of the aluminum nanosheet as prepared in the example. The experimental results include: the diameter of about (100±10) nm, and the thickness of about (8±2) nm.

Table 1 shows the comparisons between the aluminum nanosheet as prepared in Example 3 of the invention and the pure polyvinylpyrrolidone (PVP). As seen from the table, the aluminum nanomaterial as encapsulated with polyvinylpyrrolidone can exhibit the variation in the combination energy of N1s and O1s as compared to pure polyvinylpyrrolidone. Furthermore, it can be seen that aluminum is directly bonded to nitrogen and oxygen atoms, and just due to such a direct bonding, organic ligands containing nitrogen or oxygen atoms can produce controls to the morphology of the sheet structure and oxidization of the aluminum nanosheet.

TABLE 1

| Peak Position | Sample | |
|---|---|---|
| Element | PVP | PVP@Al |
| N | 399.4 | 399.7 |
| O | 530.95 | 531.61 |

### Embodiment 4

0.066 g of aluminum chloride (a metal salt), and 0.25 g of polymethyl methacrylate (PMMA) were dissolved in 10 ml of toluene, and the resultant mixture was stirred at 80° C. for 5 minutes to fully dissolve the above materials therein, thereby to form a homogenous solution A. The resultant solution was transferred into a 25 ml flask. Thereafter, 0.076 g of lithium aluminum hydride (a reductive agent) was dissolved in 10 ml of toluene to form a solution B. The solution B was added to the above flask in once, and with violent stirring, the two solutions were homogenously mixed. The mixed solution was bubbled with nitrogen/oxygen mixed gas containing 15 vol % oxygen till saturation and the air above the liquid surface is vented. The flask was placed in an oil bath in which the reaction carried on for 48 hours at 110° C., and then the flask was taken out of the oil bath and naturally cooled in air. The cooled solution was poured into a centrifugal tube to be centrifugation concentrated for 20 min with the rotary speed of 5000 rpm, and the resultant supernatant fluid was removed. Then, the concentrated suspension was dispersed with 15 ml of icy methanol, and after the dispersed suspension was ultrasonically treated for 5 minutes, it was centrifugation washed at the rotary speed of 8000 rpm. The above operations were repeated three times. The resultant product was dried under vacuum, and it was stored under oxygen isolation. FIG. 1D is a SEM diagram of the aluminum nanosheet as prepared in the example. The experimental results include: the diameter of about (1000±30) nm, and the thickness of about (18±5) nm.

### Embodiment 5

0.162 g of aluminum acetylacetonate (a metal salt) were dissolved in 10 ml of oleyl amine, and the resultant mixture was stirred for 5 min at room temperature to fully dissolve the above materials therein, thereby to form a homogenous solution A. The resultant solution was transferred into a 25 ml flask. Thereafter, 0.057 g of lithium aluminum hydride (a reductive agent) was dissolved in 10 ml of mesitylene to form a solution B. The solution B was averagely divided into 10 parts in constant volume. One part of the solution B was added to the above flask in once, and with violent stirring, the two solutions were homogenously mixed. The mixed solution was bubbled with nitrogen/oxygen mixed gas containing 20 vol % oxygen till saturation and the air above the liquid surface is vented. The flask was placed in an oil bath in which the reaction was carried on for 10 hours at 165° C., and as the reaction time went on, one part of the solution B was added to the flask every hour. After the reaction was completed, the flask was taken out of the oil bath and naturally cooled in air. The cooled solution was poured into a centrifugal tube to be centrifugation concentrated for 20 minutes with the rotary speed of 5000 rpm, and the resultant supernatant fluid was removed. Then, the concentrated suspension was dispersed with 15 ml of icy methanol, and after the dispersed suspension was ultrasonically treated for 5 minutes, it was centrifugation washed at the rotary speed of 8000 rpm. The above operations were repeated three times. The resultant product was dried under vacuum, and it was stored under oxygen isolation. FIG. 1E is a SEM diagram of the aluminum nanosheet as prepared in the example. The experimental results include: the diameter of about (100±10) nm, and the thickness of about (6±2) nm.

### Embodiment 6

A mixture of 0.0495 g of aluminum chloride and 0.0405 g of aluminum acetylacetonate (a metal salt) and 0.01 g of polyethylene glycol (PEG) were dissolved in 10 ml of mesitylene, and the resultant mixture was stirred at 80° C. for 5 min to fully dissolve the above materials therein, thereby to form a homogenous solution A. The resultant solution was transferred into a 25 ml flask. Thereafter, 0.057 g of lithium aluminum hydride (a reductive agent) was dissolved in 10 ml of mesitylene to form a solution B. The solution B was added to the above flask in once, and with violent stirring, the two solutions were homogenously mixed. The mixed solution was bubbled with nitrogen/oxygen mixed gas containing 45 vol % oxygen till saturation and the air above the liquid surface is vented. The flask was placed in an oil bath in which the reaction was carried on for 48 hours at 120° C., and then the flask was taken out of the oil bath and naturally cooled in air. The cooled solution was poured into a centrifugal tube to be centrifugation concentrated for 20 min with the rotary speed of 5000 rpm, and the resultant supernatant fluid was removed. Then, the concentrated suspension was dispersed with 15 ml of acetone, and after the dispersed suspension was ultrasonically treated for 5 minutes, it was centrifugation washed at the rotary speed of 8000 rpm. The above operations were repeated three times. The resultant product was dried under vacuum, and it was stored under oxygen isolation. FIG. 1F is a SEM diagram of the aluminum nanosheet as prepared in the example. The experimental results include: the diameter of about (230±10) nm, and the thickness of about (2±0.5) nm.

### Embodiment 7

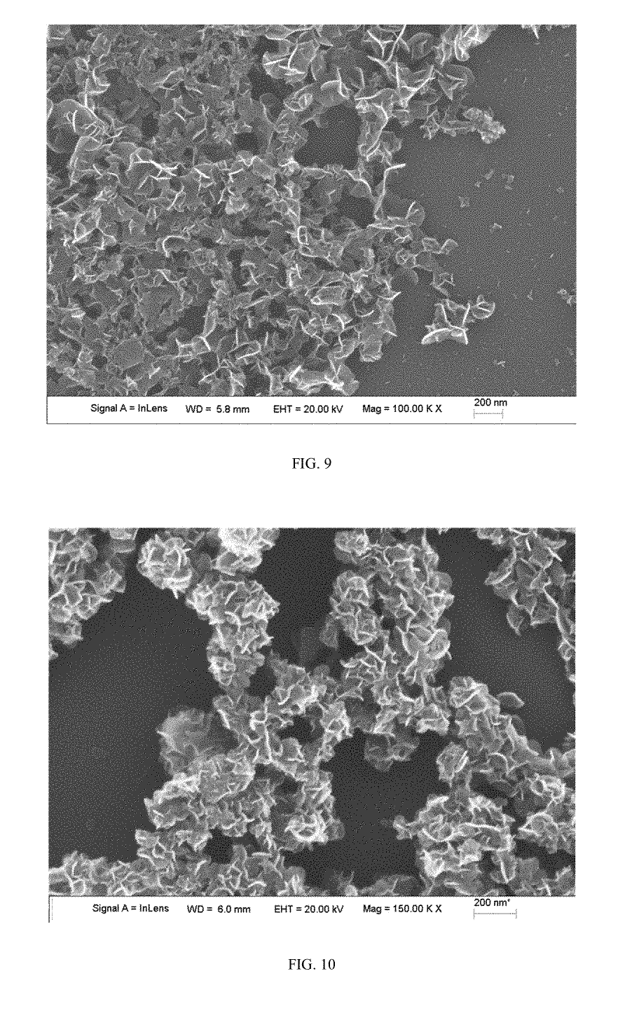

0.510 g of aluminum acetate (a metal salt), and 0.54 g of polyvinylpyrrolidone (PVP) were dissolved in 10 ml of mesitylene, and the resultant mixture was stirred at 80° C. for 5 minute to fully dissolve the above materials therein, thereby to form a homogenous solution A. The resultant solution was transferred into a 25 ml flask. Thereafter, 0.038 g of lithium aluminum hydride (a reductive agent) was dissolved in 10 ml of mesitylene to form a solution B. The solution B was added to the above flask in once, and with violent stirring, the two solutions were homogenously mixed. The mixed solution was bubbled with nitrogen/oxygen mixed gas containing 30 vol % oxygen till saturation and the air above the liquid surface is vented. The flask was placed in an oil bath in which the reaction carried on for 8 hours at 120° C., and then the flask was taken out of the oil bath and naturally cooled in air. The cooled solution was poured into a centrifugal tube to be centrifugation concentrated for 20 min with the rotary speed of 5000 rpm, and the resultant supernatant fluid was removed. Then, the concentrated suspension was dispersed with 15 ml of acetone, and after the dispersed suspension was ultrasonically treated for 5 minute, it was centrifugation washed at the rotary speed of 8000 rpm. The above operations were repeated three times. The resultant product was dried under vacuum, and it was stored under oxygen isolation. FIG. 9 is a SEM diagram of the aluminum nanosheet as prepared in the example.

### Embodiment 8

0.26 g of aluminum acetate (a metal salt), and 0.01 g of polyethylene glycol (PEG) were dissolved in 10 ml of mesitylene, and the resultant mixture was stirred at 80° C. for 5 minutes to fully dissolve the above materials therein, thereby to form a homogenous solution A. The resultant solution was transferred into a 25 ml flask. Thereafter, 0.057 g of lithium aluminum hydride (a reductive agent) was dissolved in 10 ml of mesitylene to form a solution B. The solution B was added to the above flask in once, and with violent stirring, the two solutions were homogenously mixed. The mixed solution was bubbled with nitrogen/oxygen mixed gas containing 20 vol % oxygen till saturation and the air above the liquid surface is vented. The flask was placed in an oil bath in which the reaction was carried on for 10 hours at 120° C., and then the flask was taken out of the oil bath and naturally cooled in air. The cooled solution was poured into a centrifugal tube to be centrifugation concentrated for 20 min with the rotary speed of 5000 rpm, and the resultant supernatant fluid was removed. Then, the concentrated suspension was dispersed with 15 ml of acetone, and after the dispersed suspension was ultrasonically treated for 5 minute, it was centrifugation washed at the rotary speed of 8000 rpm. The above operations were repeated three times. The resultant product was dried under vacuum, and it was stored under oxygen isolation. FIG. 10 is a SEM diagram of the aluminum nanosheet as prepared in the example.

### Embodiment 9

A mixture of 0.052 g of aluminum chloride and 0.032 g of aluminum acetylacetonate (a metal salt), and 0.01 g of polyvinylpyrrolidone (PVP) were dissolved in 10 ml of mesitylene, and the resultant mixture was stirred at 80° C. for 5 min to fully dissolve the above materials therein, thereby to form a homogenous solution A. The resultant solution was placed in a reactor. Thereafter, 0.057 g of lithium aluminum hydride (a reductive agent) was dissolved in 10 ml of mesitylene to form a solution B. The solution B was added in once to the above reactor containing the solution A, and with violent stirring, the two solutions were homogenously mixed. The mixed solution was bubbled with nitrogen/oxygen mixed gas containing 50 vol % oxygen till saturation and the air above the liquid surface is vented. The reactor was closed and placed in a thermostat in which the reaction was carried on for 10 hours at 165° C., and then the reactor was taken out of the thermostat and naturally cooled in air. The cooled solution was poured into a centrifugal tube to be centrifugation concentrated for 20 min with the rotary speed of 5000 rpm, and the resultant supernatant fluid was removed. Then, the concentrated suspension was dispersed with 15 ml of acetone, and after the dispersed suspension was ultrasonically treated for 5 minutes, it was centrifugation washed at the rotary speed of 8000 rpm. The above operations were repeated three times. The resultant product was dried under vacuum, and it was stored under oxygen isolation. FIG. 11 is a SEM diagram of the aluminum nanosheet as prepared in the example.

### Embodiment 10

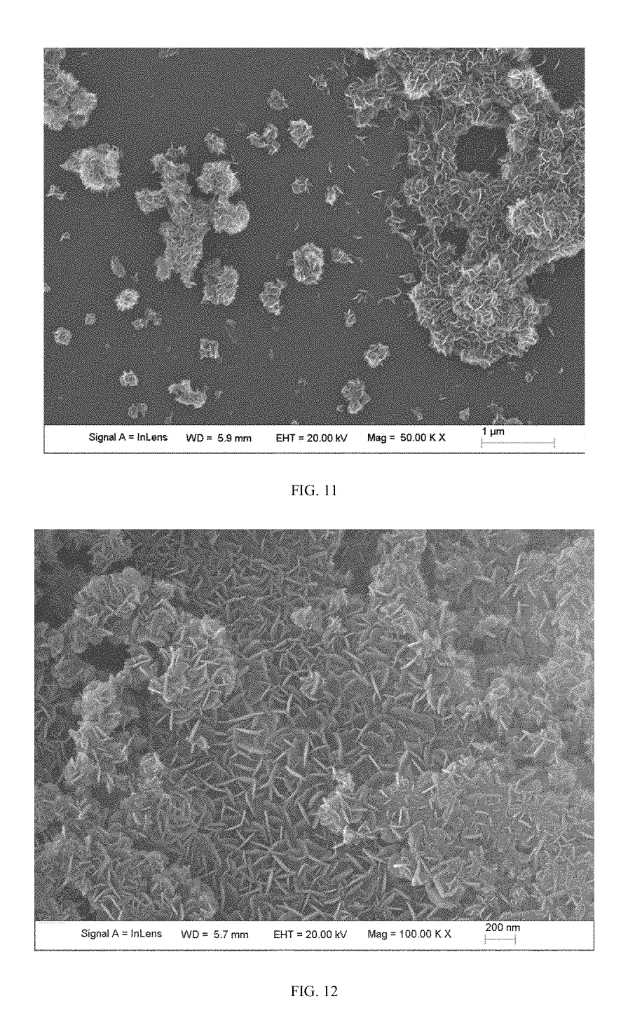

0.665 g of aluminum chloride (a metal salt) was dissolved in 10 ml of mesitylene, and the resultant mixture was stirred at 80° C. for 5 min to fully dissolve the above materials therein, thereby to form a homogenous solution A. The resultant solution was transferred into a 25 ml flask. Thereafter, 0.57 g of lithium aluminum hydride (a reductive agent) was dissolved in 10 ml of mesitylene to form a solution B. The solution B was added in once to the above flask containing the solution A, and with violent stirring, the two solutions were homogenously mixed. The mixed solution was bubbled with nitrogen/oxygen mixed gas containing 15 vol % oxygen till saturation and the air above the liquid surface is vented. The flask was placed in oil bath in which the reaction was carried on for 4 hours at 140° C., and then the flask was taken out of the oil bath and naturally cooled in air. The cooled solution was poured into a centrifugal tube to be centrifugation concentrated for 20 min with the rotary speed of 5000 rpm, and the resultant supernatant fluid was removed. Then, the concentrated suspension was dispersed with 15 ml of acetone, and after the dispersed suspension was ultrasonically treated for 5 minutes, it was centrifugation washed at the rotary speed of 8000 rpm. The above operations were repeated three times. The resultant product was dried under vacuum, and it was stored under oxygen isolation. FIG. 12 is a SEM diagram of the aluminum nanosheet as prepared in the example.

### Embodiment 11

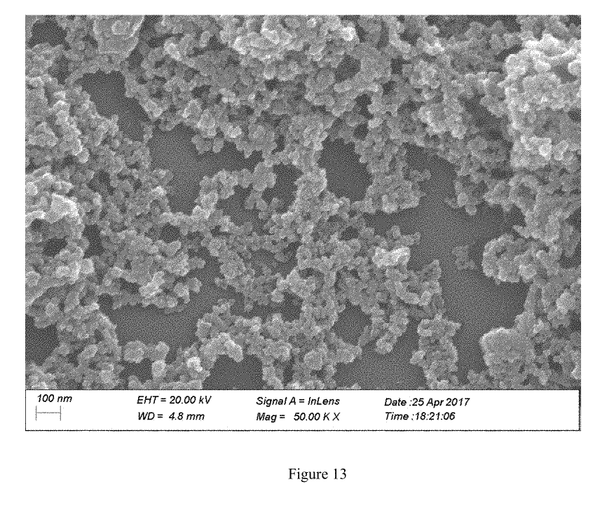

Argon was continuously bubbled into 20 ml of mesitylene for 20 minutes to sufficiently remove the dissolved oxygen in the solvent as much as possible. The solvent from which the dissolved oxygen has been removed is then placed in an oxygen-free glove box. The following steps were carried out in the glove box. 0.665 g of aluminum chloride (a metal salt), and 0.27 g of polyvinylpyrrolidone (PVP) were dissolved in 10 ml of mesitylene from which the dissolved oxygen has been removed, and the resultant mixture was stirred at 80° C. for 5 minutes to fully dissolve the above materials therein, thereby to form a homogenous solution A. The resultant solution was transferred into a 25 ml flask. Thereafter, 0.057 g of lithium aluminum hydride (a reductive agent) was dissolved in 10 ml of mesitylene from which the dissolved oxygen has been removed to form a solution B. The solution B was added to the above flask, and with violent stirring, the two solutions were homogenously mixed. The flask was placed in an oil bath in which the reaction was carried on for 4 hours at 140° C., and then the flask was taken out of the oil bath and naturally cooled in air. The cooled solution was poured into a centrifugal tube to be centrifugation concentrated for 20 min with the rotary speed of 5000 rpm, and the resultant supernatant fluid was removed. Then, the concentrated suspension was dispersed with 15 ml of acetone, and after the dispersed suspension was ultrasonically treated for 5 minute, it was centrifugation washed at the rotary speed of 8000 rpm. The above operations were repeated three times. The resultant product was dried under vacuum, and it was stored under oxygen isolation. FIG. 13 is a SEM diagram of the aluminum nanoparticles as prepared in the example.

The experimental results as shown by the drawings are sufficient to prove that the material as synthesized in the invention is a metal aluminum nanosheet having a specified morphology and a certain dispersing ability. The invention is an important progress in the field of the preparation of aluminum metal materials.

What is claimed is:

1. An aluminum nanosheet having an equivalent diameter within a range from 50 to 1000 nm, and a thickness within a range from 1.5 to 50 nm.

2. A method for preparing an aluminum nanosheet comprising:
preparing a first reaction solution by adding an aluminum source and an organic ligand to a first organic solvent;
preparing a second reaction solution by adding lithium aluminum hydride to a second organic solvent;
performing a reductive reaction by adding the second reaction solution to the first reaction solution, wherein a resultant mixture reacts at a temperature within a range from 100° C. to 165° C. for 1 to 72 hours, to produce an aluminum nanosheet suspension;
performing a solid-liquid separation on the aluminum nanosheet suspension;
wherein a produced solid is the aluminum nanosheet; and
the aluminum nanosheet having an equivalent diameter within a range from 50 to 1000 nm, and a thickness within a range from 1.5 to 50 nm.

3. The method according to claim 2, wherein the solid-liquid separation step comprises:
performing a concentration centrifugation;
performing an ultrasonic washing; and
performing a vacuum drying;
wherein washing liquid used in the ultrasonic washing is selected from the group consisting of acetone, methanol and ether or a mixture thereof.

4. The method according to claim 2 wherein the aluminum source is selected from the group consisting of aluminum chloride, aluminum acetylacetonate, and aluminum acetate or a mixture thereof; the organic ligand is selected from the group consisting of polyethylene glycol, polyvinylpyrrolidone, polymethylmethacrylate, polyethylene glycol dimethyl ether and oleyl amine; the first and second organic solvents, independently of each other, are one or more selected from the group consisting of toluene, mesitylene and butyl ether.

5. The method according to claim 2 wherein, the amount of the organic ligand is selected so that a molar ratio of the organic ligand to the aluminum nanosheet is 1:(0.01-5).

6. The method according to claim 4 wherein when aluminum chloride is used as the aluminum source, a concentration of aluminum chloride is within a range from 0.01 to 1 mol/L, and a molar ratio of the aluminum chloride to the lithium aluminum hydride is 1:(0.1-4); when aluminum acetylacetonate or aluminum acetate is used as the aluminum source, a concentration of aluminum acetylacetonate or aluminum acetate is within a range from 0.01 to 1 mol/L, and a molar ratio of the aluminum acetylacetonate or the aluminum acetate to the lithium aluminum hydride is 1:(0.05-3).

7. The method according to claim 2 wherein the reductive reaction is performed under an oxygen-containing atmosphere with an autogenous pressure in a closed reaction vessel, wherein the oxygen-containing atmosphere has an oxygen concentration within a range from 15 vol % to 50 vol %; alternatively, the reductive reaction is performed under a normal pressure in an opening reaction vessel.

8. The method according claim 2 wherein the second reaction solution is added into the first reaction solution completely or partially.

9. The method according to claim 2 wherein the thickness of the aluminum nanosheet is reduced by selecting the organic ligand having a relatively higher mass proportion of nitrogen or oxygen element; alternatively, when the same organic ligand is used, the thickness of the aluminum nanosheet is reduced by reducing the molar ratio of the organic ligand to the aluminum source.

10. The aluminum nanosheet according to claim 1 is used as a two-photon light emitting material or a Raman enhanced material.

11. The aluminum nanosheet according to claim 1 is used for increasing a light emitting intensity of a two-proton light emitting material; or, for expanding an intrinsic light emitting region from an ultraviolet region to a near infrared region by reducing the thickness of the aluminum nanosheet.

12. The method according claim 3 wherein the second reaction solution is added into the first reaction solution completely or partially.

13. The method according claim 4 wherein the second reaction solution is added into the first reaction solution completely or partially.

14. The method according claim 5 wherein the second reaction solution is added into the first reaction solution completely or partially.

15. The method according claim 6 wherein the second reaction solution is added into the first reaction solution completely or partially.
